(19) United States
(12) Patent Application Publication
(10) Pub. No.: US 2016/0028047 A1
(43) Pub. Date: Jan. 28, 2016

(54) BATTERY PACK

(71) Applicant: Samsung SDI Co., Ltd., Yongin-si (KR)

(72) Inventor: Kyungho Park, Yongin-si (KR)

(21) Appl. No.: 14/661,913

(22) Filed: Mar. 18, 2015

(30) Foreign Application Priority Data
Jul. 28, 2014 (KR) 10-2014-0096008

(51) Int. Cl. H01M 2/02; H01M 10/42

(52) U.S. Cl. CPC H01M 2/0202; H01M 10/4257; H01M 2002/0205

(57) ABSTRACT

Provided is a battery pack including a bare cell including a terrace unit having a curved shape; a support body on the terrace unit; and a flexible printed circuit board that is disposed on the support body and electrically connected to the bare cell, wherein the support body includes a first surface corresponding to the curved shape of the terrace unit, and a second surface on which the flexible printed circuit board is disposed, and the second surface includes a plurality of flat surfaces disposed in a length direction of the terrace unit.

### INCORPORATION BY REFERENCE TO ANY PRIORITY APPLICATIONS

This application claims the benefit of Korean Patent Application No. 10-2014-0096008, filed on Jul. 28, 2014, in the Korean Intellectual Property Office, the disclosure of which is incorporated herein in its entirety by reference.

### BACKGROUND OF THE INVENTION

1. Field of the Invention

One or more embodiments of the present invention relate to a battery pack.

2. Description of the Related Art

A secondary battery can be charged and discharged repeatedly whereas a primary cell cannot be recharged. In this regard, a secondary battery is economical and eco-friendly, and thus the use of a secondary battery is widely recommended.

With a variety of electric apparatuses using a secondary battery, the design element of an electric apparatus has become critical when purchasing an electronic apparatus. For example, electronic apparatuses such as cell phones and laptops are ergonomically designed to have a curved surface. Taking this trend into consideration, a secondary battery for an electronic apparatus also needs to have a curved surface corresponding to a curved surface of the electronic apparatus. In this case, since a secondary battery may include highly reactive materials, the stability thereof has to be secured to prevent the secondary battery from exploding and the like due to the excess charge and the like.

### SUMMARY OF THE INVENTION

One or more embodiments of the present invention include a battery pack that prevents damage to a protective circuit module, and in which a firm connection between a bare cell and the protective circuit module is established even when the bare cell is formed in a curved shape.

Additional aspects will be set forth in part in the description which follows and, in part, will be apparent from the description, or may be learned by practice of the presented embodiments.

According to one or more embodiments of the present invention, a battery pack includes a bare cell including a terrace unit having a curved shape, a support body on the terrace unit, and a flexible printed circuit board that is disposed on the support body and electrically connected to the bare cell. The support body may include a first surface corresponding to the curved shape of the terrace unit, and a second surface on which the flexible printed circuit board is disposed, and the second surface may include a plurality of flat surfaces disposed in a length direction of the terrace unit.

In some embodiments, the flexible printed circuit board may include electronic devices, and the electronic devices may be mounted on the flexible printed circuit board at a position where the electronic devices and the flat surfaces overlap.

In some embodiments, the plurality of flat surfaces may be placed adjacent to each other, and the respective slopes of the plurality of flat surfaces may be different from each other.

In some embodiments, the second surface may further include a curved surface formed between the plurality of flat surfaces.

In some embodiments, the flexible printed circuit board may include connection tabs, and the connection tabs may be mounted on the flexible printed circuit board at a position where the connection tabs and the flat surfaces overlap.

In some embodiments, the support body may include welding holes at positions where the welding holes and the connection tabs overlap.

In some embodiments, the bare cell may include an electrode assembly to which a first electrode tab and a second electrode tab are attached, and a pouch which seals the electrode assembly and forms the terrace unit, wherein the first electrode tab and the second electrode tab project outward through the terrace unit and are welded to the connection tabs.

In some embodiments, the first electrode tab and the second electrode tab may be firstly bent in a direction perpendicular to a length direction of the first electrode tab and the second electrode tab at a first bent position, and then, may be secondly bent in a direction toward the bare cell at a second bent position spaced apart from the first bent position

In some embodiments, the first electrode tab and the second electrode tab may respectively include a first notch and a second notch at the second bent position, and a first distance between the first bent position and the first notch may be different from a second distance between the first bent position and the second notch.

In some embodiments, a bending line which connects the first notch and the second notch may be parallel to the flat surfaces.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic perspective view of a battery pack according to an embodiment of the present invention;

FIG. 2 is a schematic cross-sectional view taken along a line I-I of FIG. 1;

FIG. 3 is a schematic side view of an aspect of the protective circuit module shown in FIG. 1;

FIG. 4 is a schematic perspective view of the bonding relationship between the bare cell and the protective circuit module shown in FIG. 1; and

FIG. 5 is a schematic side view of an aspect of the battery pack shown in FIG. 1.

### DETAILED DESCRIPTION OF THE PREFERRED EMBODIMENT

As the invention allows for various changes and numerous embodiments, exemplary embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of the related art are omitted when it is deemed that they may unnecessarily obscure the essence of the invention.

While such terms as “first”, “second”, etc., may be used to describe various components, such components must not be limited to the above terms. The above terms are used only to distinguish one component from another.

The terms used in the present specification are merely used to describe exemplary embodiments, and are not intended to limit the present invention. An expression used in the singular encompasses the expression of the plural, unless it has a clearly different meaning in the context. In the present specification, it is to be understood that the terms such as “including”, “having”, and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Reference will now be made in detail to embodiments, examples of which are illustrated in the accompanying drawings, wherein like reference numerals refer to the like elements throughout.

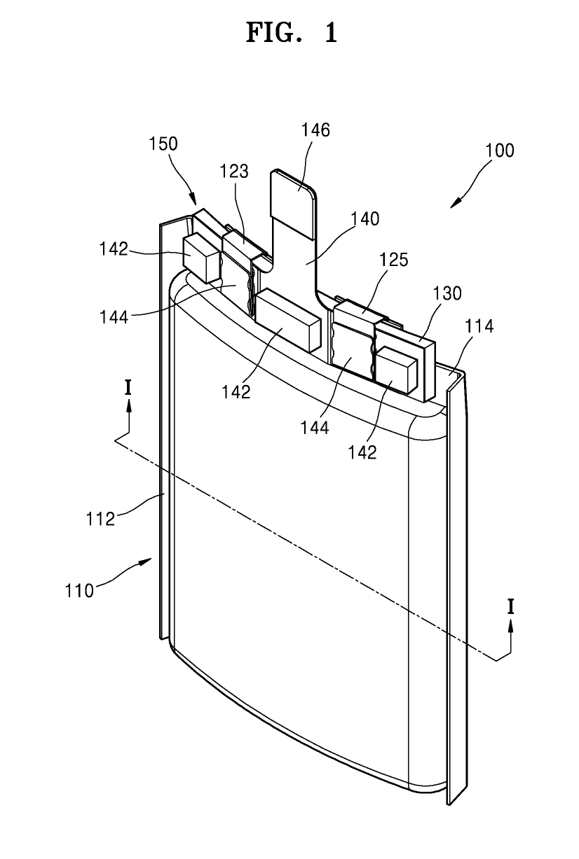

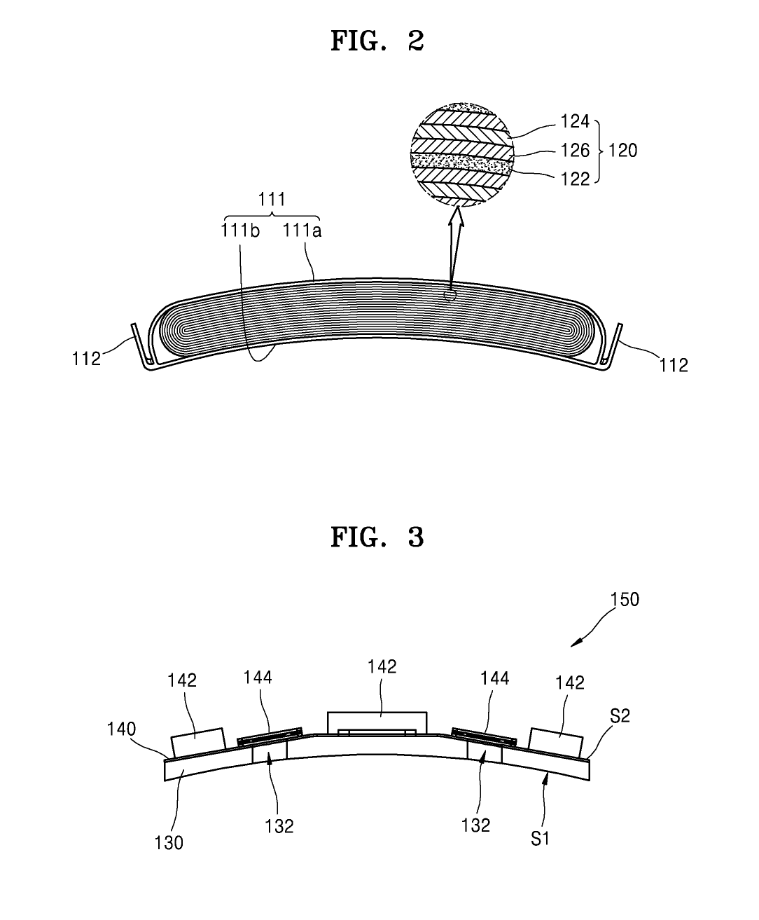

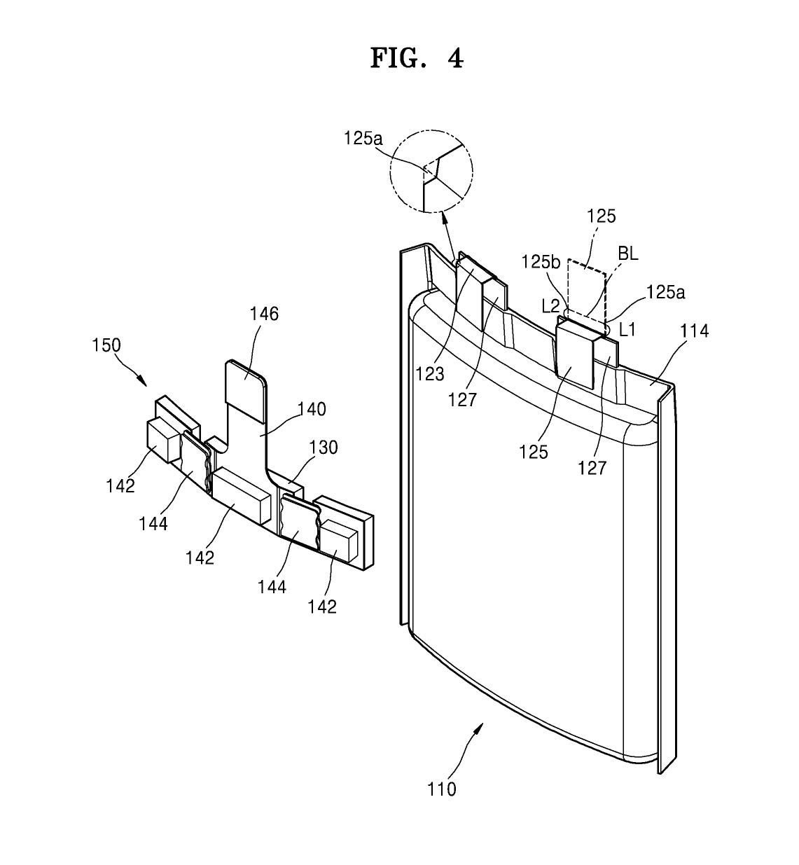

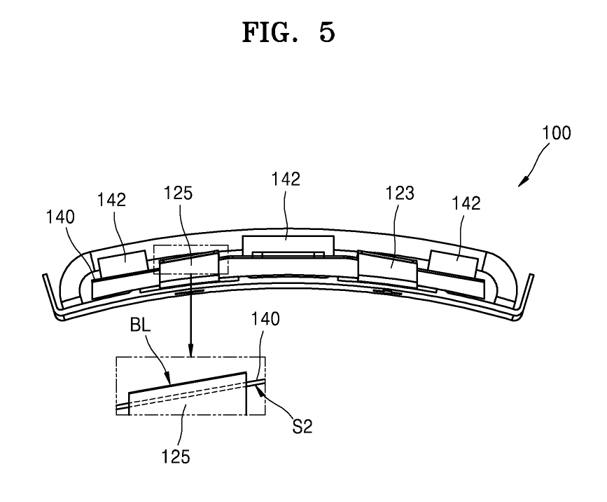

FIG. 1 is a schematic perspective view of a battery pack according to an embodiment of the present invention; FIG. 2 is a schematic cross-sectional view taken along a line I-I of FIG. 1; FIG. 3 is a schematic side view of an aspect of the protective circuit module shown in FIG. 1; FIG. 4 is a schematic perspective view of the bonding relationship between the bare cell and the protective circuit module shown in FIG. 1; and FIG. 5 is a schematic side view of an aspect of the battery pack shown in FIG. 1.

Referring to FIGS. 1 to 5, a battery pack 100 according to an embodiment of the present invention may include a bare cell 110 and a protective circuit module 150 that is electrically connected to the bare cell 110.

The bare cell 110 may be repeatedly charged and discharged as a secondary battery. The bare cell 110 may include an electrode assembly 120 and a pouch 111 that seals the electrode assembly 120.

The electrode assembly 120 may include a first electrode plate 122, a second electrode plate 124, and a separator 126 disposed therebetween. For example, the electrode assembly 120 may be formed by stacking the first electrode plate 122, the separator 126 and the second electrode plate 124 in the above order, and winding the stacked substances as a jelly roll type.

The first electrode plate 122 may be one of a positive electrode film and a negative electrode film. If the first electrode plate 122 is the positive electrode film, the second electrode plate 124 may be the negative electrode film, whereas if the first electrode plate 122 is the negative electrode film, the second electrode plate 124 may be the positive electrode film. In other words, the first electrode plate 122 and the second electrode plate 124 may be formed to have polarities opposite to each other, but the polarity of each plate is not limited thereto. Hereinafter, the first electrode plate 122 is, however, deemed to be the positive electrode film and the second electrode plate 124 is deemed to be the negative electrode film.

The first electrode plate 122 may include a first active material unit coated with a first active material, and a first plain unit which is not coated with the first active material. The first active material unit, for example, may be formed by coating some portions of at least one side of an aluminum plate with the first active material. The other side of the aluminum plate, which is not coated with a first active material, may be the first plain unit. The first active material may be a nickel-based lithium transition metal oxide such as LiCoO2, LiNiO2, LiMnO2, LiMnO4, or a positive electrode active material such as lithium chalcogenide compound.

The second electrode plate 124 may include a second active material unit coated with a second active material, and a second plain unit which is not coated with the second active material. The second active material unit, for example, may be formed by coating some portions of at least one side of a copper plate with the second active material. The other side of the aluminum plate, which is not coated with a first active material, may be the second plain unit. The second active material, for example, may be a negative electrode active material. In detail the negative electrode active material may be lithium metal or lithium alloy, or a carbon material such as crystalline carbon, amorphous carbon, or a carbon composite.

The separator 126 may be formed of a porous polymer film such as a porous polyethylene film or a porous polypropylene film. The separator 126 may further include ceramic particles. The separator 116 may be formed of a solid polymer electrolyte. The separator 126 may be an independent film or may be a porous layer formed on the first electrode plate 122 or the second electrode plate 124.

The electrode assembly 120 may include a first electrode tab 123 and a second electrode tab 125. For example, the first electrode tab 123 is attached to the first plain unit of the first electrode plate 122 by welding or the like whereas the second tab 125 is attached to the second plain unit of the second electrode plate 124 by welding or the like, and thus the current generated in the electrode assembly 120 may be transmitted outward. Also, the first electrode tab 123 may be integrally formed with the first plain unit of the first electrode plate 122 while the second electrode tab 125 may be integrally formed with the second plain unit of the second electrode plate 124.

The pouch 111 may seal the electrode assembly 120, and may accommodate an electrolyte together with the electrode assembly 120. For example, the pouch 111 may include a first sealing sheet 111a disposed on a first surface of the electrode assembly 120, and a second sealing sheet 111b disposed on a second surface of the electrode assembly 120.

The first sealing sheet 111a and the second sealing sheet 111b may each include a first insulating layer, a metal layer, and the second insulating layer. As an example, the metal layer may be formed with aluminum, stainless steel, and the like while the first insulating layer and the second insulating layer may be formed with chlorinated polypropylene (CPP), polyethyleneterephthalate (PET), nylon, and the like. However, the present invention is not limited to the aforementioned examples.

As another example, the first sealing sheet 111a may provide an accommodation space, by a drawing process, which may accommodate the electrode assembly 120. After the electrode assembly 120 is accommodated in the accommodation space, the second sealing sheet 111b having an edge continuously connected to an edge of the first sealing sheet 111a may be folded over the first sealing sheet 111a, and then edge portions of the first and second sealing sheets 111a and 111b may be joined together along the boundary of the accommodation space by thermal bonding.

Thus, the pouch 111 may seal the electrode assembly 120 and a pair of side wings 112 and a terrace unit 114 may be formed at the edges where the first sealing sheet 111a and the second sealing sheet 111b are coupled with each other.

The pair of side wings 112 may be bent parallel to the side of the bare cell 110. The first electrode tab 123 and the second electrode tab 125 may project outward through the terrace unit 114, and an insulating tape 127 may be placed at positions where the first electrode tab 123 and the second electrode tab 125 respectively overlap with the terrace unit 114.

Meanwhile, the bare cell 110 may be formed in a curved shape depending on the shape of an electric apparatus to which the bare cell 110 is mounted. For example, the bare cell 110 may be placed in a jig, and then pressure may be applied to the bare cell 100 by the jig in order to form a curved shape. If the bare cell 110 has a curved shape depending on the shape of an electric apparatus to which the bare cell 110 is mounted, an inner space of the electric apparatus may be utilized efficiently and damage to the battery pack 100 due to detachment and movement of the battery pack 100 inside the electronic apparatus may be prevented. Also, when the bare cell 110 is formed in a curved shape, the terrace unit 113 may also be formed in a curved shape.

The protective circuit module 150 may be disposed on the terrace unit 114. The protective circuit module 150 may include a support body 130 and a flexible printed circuit board 140 on the support body 130.

The support body 130 may be formed with an insulating material such as polycarbonate and acrylic. The support body 130 may be attached to the terrace unit 114 by an adhesion layer and the like. The support body 130 may include a first surface S1 which contacts the terrace unit 114, and a second surface S2 which is the surface opposite to the first surface S1.

The first surface S1 may be formed to correspond to the shape of the terrace unit 114. For example, if the terrace unit 114 is formed having a certain curvature, the first surface S1 may be formed having the same curvature as the terrace unit 114. In this regard, even when the protective circuit module 150 is disposed on the terrace unit 114 having the curved shape, the protective circuit module 150 may be stably disposed such that the protective circuit module 150 is firmly coupled to the bare cell 110.

The second surface S2 may include a plurality of flat surfaces. Here, the term plurality refers to two or more. The plurality of flat surfaces may be disposed in a length direction of the terrace unit 114. Also, the plurality of flat surfaces may be disposed adjacent to each other, and the slopes thereof may be different from each other.

The flexible printed circuit board 140 may be disposed on the second surface S2. The flexible printed circuit board 140 may be closely attached to the second surface S2 depending on the shape of the second surface S2, due to the flexibility of the flexible printed circuit board 140. The flexible printed circuit board 140 may be attached to the second surface S2 by the adhesion layer and the like.

The flexible printed circuit board 140 may be electrically connected to the bare cell 110 to prevent the excessive charge and the excessive discharge of the bare cell 110. To this end, the flexible printed circuit board 140 may include connection tabs 144 and electronic devices 142, which are connected to the first electrode tab 123 or the second electrode tab 125. Also, the flexible printed circuit board 140 may further include a connection terminal 146 to be connected to the external electronic apparatus.

The connection tabs 144 may be connected to the first electrode tab 123 and the second electrode tab 125 by welding. For example, each of the connection tabs 144 may be a piece of metal that can be folded in half. Here, the first electrode tab 123 or the second electrode tab 124 is inserted into and then may be welded to a connection tab 144 which is half-folded and corresponds thereto. In other words, the connection tab 144, which is half-folded, may be welded to both the upper surface and the bottom surface of the first electrode tab 123 or the second electrode tab 125. Meanwhile, the support body 130 may include welding holes 132 into which welding sticks can be inserted at positions where the welding holes 132 and the connection tabs 144 overlap.

The connection tabs 144 may be mounted on the flexible printed circuit board 140 at positions where the connection tabs 144 overlap with the plurality of flat surfaces. Therefore, the connection tabs 144 are disposed on the flat surfaces when being welded thereto, and thus the first electrode tab 123 or the second electrode tab 125 may be easily welded to a connection tab 144 corresponding thereto.

After the first electrode tab 123 and the second electrode tab 124 are welded to the connection tabs 144, the first electrode tab 123 and the second electrode tab 125 may be bent so that the protective circuit module 150 is disposed on the terrace unit 114. For this, the first electrode tab 123 and the second electrode tab 125 may be bent in a “shape.

For example, the first electrode tab 123 and the second electrode tab 125 may be firstly bent in a direction perpendicular to a length direction of the first electrode tab 123 and the second electrode tab 125 at a first bent position. Then, the first electrode tab 123 and the second electrode tab 125 may be secondly bent in a direction toward the bare cell 110 at a second bent position spaced apart from the first bent position.

The first bent position, for example, may be a border line between the insulating tape 127 and the first electrode tab 123 or the second electrode tab 125, but the present invention is not limited to thereto. The first bent position may be anywhere on both electrode tabs. However, the first electrode tab 123 is firstly bent along the imaginary horizontal line in a width direction, which is the shortest distance between two ends of the first electrode tab 123. Likewise, the second electrode tab 125 may also be firstly bent along with the imaginary horizontal line in a width direction, which is the shortest length of the second electrode tab 125.

The second bent position may be freely determined while considering the thickness of the protective circuit module 150. Meanwhile, the first electrode tab 123 and the second electrode tab 125 may respectively include a first notch 125a and a second notch 125b so that the first electrode tab 123 and the second electrode tab 125 may be secondly bent in an easy manner.

The first notch 125a and the second notch 125b are concave portions that are formed at both sides of the first electrode tab 123 and the second electrode tab 125 in a width direction of the first electrode tab 123 and the second electrode tab 125, and may determine the second bent position where the first electrode tab 123 and the second electrode tab 125 are secondly bent. In other words, the first electrode tab 123 and the second electrode tab 125 may be secondly bent along a bending line BL which connects the first notch 125a and the second notch 125b.

In this case, a first distance L1 between the first bent position and the first notch 126a and a second distance L2 between the first bent position and the second notch 126b may be different from each other, and thus the bending line BL connecting the first notch 126a and the second notch 126b may be an oblique line across the first electrode tab 123 and the second electrode tab 125.

The bent line BL may also be parallel to the flat surface on which the connection tabs 144 are mounted. In this case, the first electrode tab 123 and the second electrode tab 125 that are bent along the bending line BL may be formed parallel to the flat surface on which the connection tabs 144 are mounted. Therefore, even when the first electrode tab 123 and the second electrode tab 125 are welded to the connection tabs 144 and then bent, the first electrode tab 123 and the second electrode tab 125 may be parallel to the connection tabs 144 and so that the welded state may be stably maintained.

The flexible printed circuit board 140 may include electronic devices 142. Examples of the electronic devices 142 are resistors, capacitors, and the like, and the electronic devices 142 may be mounted on the flexible printed circuit board 140 at positions where the electronic devices 142 overlap with the flat surfaces. Therefore, even when the protective circuit module 150 is disposed on the terrace unit 114 having the curved shape, the protective circuit module 150 is not curved. In this regard, detachment of the electronic devices 142, damage to the protective circuit module 150, and so forth that occur when the protective circuit module 150 is curved may be prevented or at least inhibited, and thus the stability of the battery pack 100 is secured.

Although not shown in the FIGS, the second surface S2 may further include a curved surface between the plurality of flat surfaces. If the curved surface is formed between the plurality flat surfaces, the flexible printed circuit board 140 may be prevented from being bent at the border line between two adjacent flat surfaces, and thus the circuit pattern of the flexible printed circuit board 140 may be protected.

As described above, according to the one or more of the above embodiments of the present invention, stability of a battery pack may be secured since the battery pack prevents damage to a protective circuit module, and a firm connection between a bare cell and the protective circuit module is established even when the bare cell is formed in a curved shape.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A battery pack comprising:
a bare cell including a terrace unit having a curved shape;
a support body on the terrace unit; and
a flexible printed circuit board that is disposed on the support body and electrically connected to the bare cell,
wherein the support body comprises a first surface corresponding to the curved shape of the terrace unit, and a second surface on which the flexible printed circuit board is disposed,
the second surface comprises a plurality of flat surfaces disposed in a length direction of the terrace unit.

2. The battery pack of claim 1, wherein the flexible printed circuit board comprises electronic devices, and
the electronic devices are mounted on the flexible printed circuit board at a position where the electronic devices and the flat surfaces overlap.

3. The battery pack of claim 1, wherein the plurality of flat surfaces are placed adjacent to each other, and
the respective slopes of the plurality of flat surfaces are different from each other.

4. The battery pack of claim 1, wherein the second surface further comprises a curved surface formed between the plurality of flat surfaces.

5. The battery pack of claim 1, wherein the flexible printed circuit board comprises connection tabs, and
the connection tabs are mounted on the flexible printed circuit board at a position where the connection tabs and the flat surfaces overlap.

6. The batter pack of claim 5, wherein the support body comprises welding holes at positions where the welding holes and the connection tabs overlap.

7. The battery pack of claim 5, wherein the bare cell comprises:
an electrode assembly to which a first electrode tab and a second electrode tab are attached, and
a pouch which seals the electrode assembly and forms the terrace unit,
wherein the first electrode tab and the second electrode tab project outward through the terrace unit and are welded to the connection tabs.

8. The battery pack of claim 7, wherein the first electrode tab and the second electrode tab are firstly bent in a direction perpendicular to a length direction of the first electrode tab and the second electrode tab at a first bent position, and then, are secondly bent in a direction toward the bare cell at a second bent position spaced apart from the first bent position.

9. The battery pack of claim 8, wherein the first electrode tab and the second electrode tab respectively comprise a first notch and a second notch at the second bent position and a first distance between the first bent position and the first notch is different from a second distance between the first bent position and the second notch.

10. The battery pack of claim 9, wherein a bending line which connects the first notch and the second notch is parallel to the flat surfaces.

11. A battery pack comprising:
a bare cell with a housing that defines a terrace that is curved across the width of the terrace;
a support body that is positioned on the curved terrace, wherein the support body has a first surface that is curved and in contact with the curved surface of the terrace and a second body that comprises a plurality of sections that have a flat outer surface;
a flexible printed circuit board that includes electronic devices, wherein the electronic devices are mounted on the flexible printed circuit board at locations that correspond to the flat surfaces of the support body.

12. The battery pack of claim 11, wherein the plurality of flat surfaces are placed adjacent to each other, and
the respective slopes of the plurality of flat surfaces are different from each other.

13. The battery pack of claim 11, wherein the flexible printed circuit board comprises connection tabs, and
the connection tabs are mounted on the flexible printed circuit board at a position where the connection tabs and the flat surfaces overlap.

14. The batter pack of claim 13, wherein the support body comprises welding holes at positions where the welding holes and the connection tabs overlap.

15. The battery pack of claim 13, wherein the bare cell comprises:
an electrode assembly to which a first electrode tab and a second electrode tab are attached, and
a pouch which seals the electrode assembly and forms the terrace unit,
wherein the first electrode tab and the second electrode tab project outward through the terrace unit and are welded to the connection tabs.

16. The battery pack of claim 15, wherein the first electrode tab and the second electrode tab are firstly bent in a direction perpendicular to a length direction of the first electrode tab and the second electrode tab at a first bent position, and then, are secondly bent in a direction toward the bare cell at a second bent position spaced apart from the first bent position.

17. The battery pack of claim 16, wherein the first electrode tab and the second electrode tab respectively comprise a first notch and a second notch at the second bent position and a first distance between the first bent position and the first notch is different from a second distance between the first bent position and the second notch.

18. The battery pack of claim 17, wherein a bending line which connects the first notch and the second notch is parallel to the flat surfaces.
